(19) United States
(12) Patent Application Publication
(10) Pub. No.: US 2014/0335277 A1
(43) Pub. Date: Nov. 13, 2014

(54) REINFORCED ARTICLES AND METHODS OF MAKING THE SAME

(71) Applicant: GENERAL ELECTRIC COMPANY, Schenectady, NY (US)

(72) Inventors: Rupak Das, Greenville, SC (US); Jon Conrad Schaeffer, Simpsonville, SC (US)

(21) Appl. No.: 14/338,881

(22) Filed: Jul. 23, 2014

Related U.S. Application Data
(62) Division of application No. 13/566,680, filed on Aug. 3, 2012.

(51) Int. Cl. B05D 1/36

(52) U.S. Cl. CPC B05D 1/36
USPC 427/402

(57) ABSTRACT

A method includes disposing a bond layer on a substrate; disposing a reinforcing layer on the bond layer, the reinforcing layer comprising hydrogen; and disposing a protective layer on the reinforcing layer, wherein the reinforcing layer reduces formation of thermally grown oxide generated at the bond layer.

### CROSS-REFERENCE TO RELATED APPLICATIONS

This application claims priority to non-provisional application 13/566,680, filed on Aug. 3, 2012, the entire contents of which are hereby incorporated by reference.

### BACKGROUND OF THE INVENTION

The subject matter disclosed herein relates to reinforced articles, such as gas turbine engine components, and more particularly to reinforced articles which are creep resistant, and methods of making the same.

Gas turbine engines accelerate gases, forcing the gases into a combustion chamber where heat is added to increase the volume of the gases. The expanded gases are then directed toward a turbine to extract the energy generated by the expanded gases. In order to endure the high temperatures and extreme operating conditions in gas turbine engines, gas turbine engine components, such as turbine blades, are fabricated from metal, ceramic or ceramic matrix composite materials.

Environmental barrier coatings are applied to the surface of gas turbine engine components to provide added protection and to thermally insulate the gas turbine engine components during operation of the gas turbine engine at high temperatures. An environmental barrier coating is at least one protective layer which is applied to a component, or a substrate, using a bond layer. The protective layer is a ceramic material and can also include multiple layers. The hot gas environment in gas turbine engines results in oxidation of the bond layer and formation of a thermally grown oxide layer at the interface between the bond layer and the protective layer.

The thermally grown oxide layer creeps into one or more layers of the environmental barrier coating as a result of shear stress due to, for example, centrifugal load or mismatch of thermal expansion with the outer protective layers of the environmental barrier coating. Creep of the thermally grown oxide layer causes cracking in the outer protective layers of the environmental barrier coating and/or substrate and/or reduces the overall lifetime of the component.

It is therefore desirable to provide reinforced articles having improved creep resistance, oxidation resistance and/or temperature resistance and methods of making the same, which solve one or more of the aforementioned problems.

### BRIEF DESCRIPTION OF THE INVENTION

According to one aspect of the invention, a method comprises disposing a bond layer on a substrate; disposing a reinforcing layer on the bond layer, the reinforcing layer comprising hydrogen; and disposing a protective layer on the reinforcing layer, wherein the reinforcing layer reduces formation of thermally grown oxide generated at the bond layer.

These and other advantages and features will become more apparent from the following description taken together in conjunction with the accompanying drawings.

### BRIEF DESCRIPTION OF THE DRAWINGS

The subject matter, which is regarded as the invention, is particularly pointed out and distinctly claimed in the claims at the conclusion of the specification.

The foregoing and other features, and advantages of the invention are apparent from the following detailed description taken in conjunction with the accompanying drawings in which:

FIG. 1 is a partial cross-sectional view of an article;

FIG. 2 is a partial cross-sectional view of another article; and

FIG. 3 is a partial cross-sectional view of another article.

The detailed description explains embodiments of the invention, together with advantages and features, by way of example with reference to the drawings.

### DETAILED DESCRIPTION

Embodiments described herein generally relate to reinforced articles and methods of making the same. A reinforcing layer is provided for use in conjunction with a substrate, a bond layer and a protective layer.

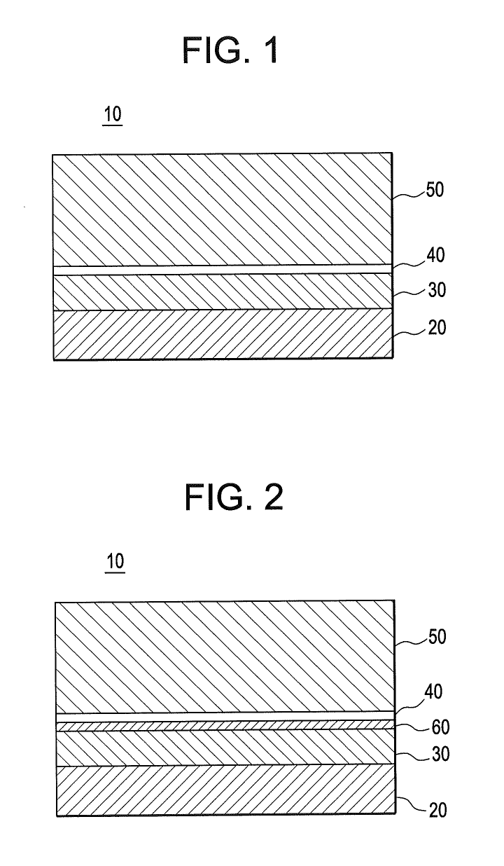

Referring to FIG. 1, an article 10 comprises a substrate 20. A bond layer 30 is disposed on the substrate 20. A reinforcing layer 40 is disposed on the bond layer 30. A protective layer 50 is disposed on the reinforcing layer 40.

The substrate 20 is a metal, ceramic, or ceramic matrix composite (CMC) material. In one embodiment, the substrate 20 is gas turbine engine component. In another embodiment, the substrate is a turbine blade, vane, shroud, liner, combustor, transition piece, rotor component, exhaust flap, seal or fuel nozzle. In yet another embodiment, the substrate 20 is a turbine blade formed using a CMC material.

The bond layer 30 assists in bonding the protective layer 50 to the substrate 20. In one embodiment, the bond layer 30 comprises silicon.

The protective layer 50 protects the substrate from the effects of environmental conditions to which the article 10 is subjected during operation such as hot gas, water vapor and/or oxygen. The protective layer 50 is any material suitable to protect the substrate 20 from being contacted with hot gas, water vapor and/or oxygen when the article 10 is in operation. In one embodiment, the protective layer 50 comprises a ceramic material. In another embodiment, the protective layer 50 comprises silicon.

In one embodiment, the protective layer 50 comprises a single layer. In another embodiment, the protective layer 50 comprises multiple layers of various materials. In yet another embodiment, the protective layer 50 is an environmental barrier coating (EBC) comprising multiple layers of various materials.

The protective layer 50 is disposed on the reinforcing layer 40 using any suitable method, including but not limited to, atmospheric plasma spray (APS), chemical vapor deposition (CVD), plasma enhanced CVD (PECVD), dip coating, spin coating and electro-phoretic deposition (EPD).

During the operation of the article 10 at high temperatures, exposure to hot gases, water vapor and/or oxygen results in oxidation of the bond layer 30. Upon melting and oxidation, the bond layer 30 forms a viscous fluid layer (not shown), such as a viscous glass layer. The viscous fluid layer comprises thermally grown oxide (TGO). The viscous fluid layer moves, or slides, under shear stress caused by centrifugal load applied to the article 10 during operation and a mismatch of the coefficients of thermal expansion with the protective layer 50. This phenomenon is referred to as “creep”. The creep of the protective layer 50 results in cracking and/or reduces the overall lifetime of the component.

The reinforcing layer 40 is disposed at an interface between the bond layer 30 and the protective layer 50 using any of the same methods used to apply the protective layer 50. In one embodiment, the reinforcing layer 40 is applied using spin coating. In another embodiment, the reinforcing layer 40 is a continuous layer which is continuous with a surface of the bond layer 30.

The reinforcing layer 40 reduces, hinders or inhibits thermally grown oxide generated at the bond layer 30. The reinforcing layer 40 comprises hydrogen.

In one embodiment, the hydrogen molecules in the reinforcing layer 40 reduce or inhibit thermally grown oxide generated at the bond layer 30 by passivating the surface of the bond layer 30, whereby the hydrogen molecules form hydrogen bonds with the bond layer 30. The formation of these hydrogen bonds leaves less potential reaction sites available for oxidation of the bond layer 30 when contacted by oxygen or oxide ions.

In another embodiment, the interaction between the hydrogen molecules in the reinforcing layer 40 with the bond layer 30 and formation of hydrogen bonds results in the formation of a mesh-like network in the reinforcing layer 40. This network serves as a mechanical/chemical barrier to oxidation of the bond layer 30. The resulting network is superhydrophobic, trapping air and hot gas within pores formed in the network. The nano-porous transport of hot gas results in a mean free path which is less than the diameter of a passage, decreasing the surface free energy of the reinforcing layer 40. Contact between hot gas and the bond layer 30 is reduced or inhibited, thereby reducing or inhibiting the amount of thermally grown oxide generated at the bond layer 30. The reinforcing layer 40 also assists in bonding, or adhering, the bond layer 30 to the protective layer 50.

In yet another embodiment, a fraction or all of the hydrogen molecules in the reinforcing layer 40 react with oxygen molecules present in a thermally grown oxide layer generated at the bond layer 30. The hydrogen molecules in the reinforcing layer 40 provide a competing reaction to the reaction of the bond layer 30. This competing reaction reduces the amount of material loss due to oxidation of the bond layer 30. This competing reaction also reduces or inhibits the formation of thermally grown oxide generated at the bond layer 30.

Referring to FIG. 2, in still another embodiment, the reinforcing layer 40 reverses oxidation of the bond layer 30, thereby reversing the effects of creep. The hydrogen molecules in the reinforcing layer 40 react with silicon dioxide (SiO₂) in a thermally grown oxide layer 60 generated by oxidation of the bond layer 30. The hydrogen molecules remove and bond with oxygen atoms of the silicon dioxide. The removal of oxygen from the thermally grown oxide layer 60 reverses the formation of the thermally grown oxide layer 60, reducing or inhibiting creep.

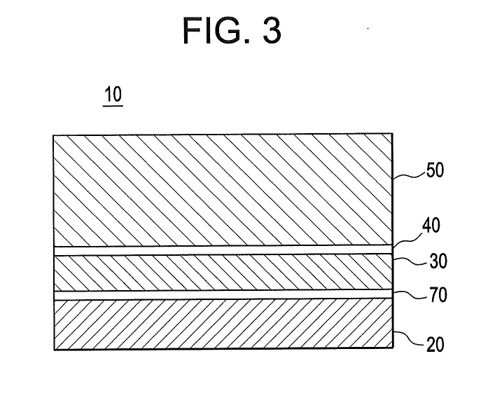

Referring to FIG. 3, in one embodiment, the article 10 further comprises an additional reinforcing layer 70. The additional reinforcing layer 70 is disposed on the substrate 20, between the substrate 20 and the bond layer 30. The additional reinforcing layer 70 comprises the same materials, is disposed using the same methods, and has the same properties as described above with regard to the reinforcing layer 40. In one embodiment, the additional reinforcing layer 70 comprises the same materials, is disposed using the same method and has the same properties as the reinforcing layer 40. In another embodiment, the additional reinforcing layer 70 comprises different materials and/or is disposed on the substrate 20 using a different method and/or has different properties than the reinforcing layer 40. The additional reinforcing layer 70, in conjunction with the bond layer 30, assists in bonding the protective layer 50 to the substrate 20.

The thickness of the reinforcing layer 40 and/or the additional reinforcing layer 70 is from about 1 nm to about 100 μm. In another embodiment, the thickness of the reinforcing layer 40 and/or the additional reinforcing layer 70 is from about 1 nm to about 50 μm. In yet another embodiment, the thickness of the reinforcing layer 40 and/or the additional reinforcing layer 70 is from about 1 nm to about 10 μm. In still yet another embodiment, the thickness of the reinforcing layer 40 and/or the additional reinforcing layer 70 is uniform or substantially uniform.

The reinforcing layer 40 and/or the additional reinforcing layer 70 provide improved oxidation resistance, creep resistance and/or temperature resistance of equal to or greater than 2400° F., thereby improving the performance and overall lifetime of the article 10.

In one embodiment, a method comprises disposing the bond layer 30 on a substrate 20, disposing a reinforcing layer 40 on the bond layer 30 and disposing a protective layer 50 on the reinforcing layer 40. In another embodiment, the method further comprises disposing an additional reinforcing layer 70 between the substrate 20 and the bond layer 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method comprising:
disposing a bond layer on a substrate;
disposing a reinforcing layer on the bond layer, the reinforcing layer comprising hydrogen; and
disposing a protective layer on the reinforcing layer,
wherein the reinforcing layer reduces formation of thermally grown oxide generated at the bond layer.

2. The method of claim 1, wherein the substrate comprises a ceramic or a ceramic matrix composite.

3. The method of claim 1, wherein the bond layer comprises silicon.

4. The method of claim 1, wherein the reinforcing layer chemically reacts with thermally grown oxide generated at the bond layer.

5. The method of claim 1, wherein the reinforcing layer passivates a surface of the bond layer by forming hydrogen bonds.

6. The method of claim 1, further comprising disposing an additional reinforcing layer between the substrate and the bond layer, the additional reinforcing layer comprising hydrogen, wherein the additional reinforcing layer reduces formation of thermally grown oxide generated at the bond layer.

7. The method of claim 1, wherein the protective layer comprises at least two layers.

8. The method of claim 1, wherein the substrate is a gas turbine engine component.

9. The method of claim 1, wherein the substrate is a turbine blade, vane, shroud, liner, combustor, transition piece, rotor component, exhaust flap, seal or fuel nozzle.

10. The method of claim 1, wherein the protective layer is an environmental barrier coating.
